(19) United States
(12) Patent Application Publication
(10) Pub. No.: US 2004/0199872 A1
(43) Pub. Date: Oct. 7, 2004

(54) Pre-production processing of an electronic document

(76) Inventors: Kenneth L. Oakeson, Boise, ID (US); Roger Scott Twede, Meridian, ID (US); Shell Sterling Simpson, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/405,835

(22) Filed: Apr. 2, 2003

(51) Int. Cl. G06F 15/00

(52) U.S. Cl. 715/515

(57) ABSTRACT

Pre-production processing an electronic document in which programming responsible for processing the composition need not have any inherent knowledge of programming responsible for manipulating one or more of the elements. A method embodying the invention includes creating a composition comprising a series of directions for retrieving one or more elements from one or more data stores and assembling those elements into a document. One of the composition's directions is then edited by adding data identifying an imaging service responsible for manipulating a particular element when the composition is processed.

### BACKGROUND

The present invention is directed to a method and system for electronic document production. More particularly, the present invention is directed toward a method and system for establishing and managing a workflow for pre-production processing of an electronic document.

In a basic desktop computing environment, a printer or other production service is connected directly to a computer. Production services include printers; finishers such as binders, sorters, or folders; e-mail clients; facsimile devices; and electronic data storage devices. However, production services are not limited to those listed, but may include any device capable of electronically or physically saving, displaying, formatting, or transferring an electronic document.

To produce a document, a user first either opens or creates an electronic document using a word processor or other application. The user then issues a production request identifying a production service. A driver, specific to the selected production device—a printer in this example—generates a user interface allowing the user to select options for formatting the document. Among others, these options can include the number of copies, print resolution, specific paper source and output bins. With the desired production options selected, the driver formats the production request into a specialized series of commands directing the printer to produce the document on one or more sheets of paper.

In a distributed computing environment, document production can become more complex. A document can be viewed as a series of elements selectively placed on one or more pages. These elements generally fall into one of two types—text and graphics. However, other types of elements are possible. For example, an electronic document may have an embedded audio file. Each element of an electronic document can be physically stored on a separate device. The text of the document my be found in word processing files stored on two or more devices while any graphics may be stored on yet another device.

To link each of the elements into a single document, a user creates a composition. A composition is a series of directions guiding the retrieval and placement of each element on one or more pages. These pages may be electronic pages and/or the physical pages of a printed document. To produce the document, the composition is processed. Following the composition's directions, each element is retrieved and assembled into a coherent, albeit electronic, document. The processed composition is then directed to a selected production service.

Before the document is produced, however, a user may desire to manipulate one or more elements, as the composition is being processed. For example, the user may want to apply a filter to a graphic element to decrease the color depth. The user may desire to manipulate assembled elements to reorder and/or flip the resulting pages. Unfortunately, the programming responsible for manipulating the elements of the document is often independent and unknown to the programming responsible for processing the composition.

### DESCRIPTION OF THE DRAWINGS

FIG. 1 is a schematic representation of a computer network that includes an imaging repository, several imaging services, one or more production services, and a client.

FIG. 2 is a block diagram of the network of FIG. 1 in which various embodiments of the present invention may be incorporated.

FIG. 3 is a schematic representation of a document represented by a composition instructing the processing of a series of elements retrieved from a number of data stores according to an embodiment of the present invention.

FIG. 4 is a table illustrating a composition according to an embodiment of the present invention.

FIG. 5 is a flow diagram illustrating the steps taken to produce a document according to an embodiment of the present invention.

### DETAILED DESCRIPTION OF THE INVENTION

### GLOSSARY

Program: An organized list of electronic instructions that, when executed, causes a device to behave in a predetermined manner. A program can take many forms. For example, it may be software stored on a computer's disk drive. It may be firmware written onto read-only memory. It may be embodied in hardware as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components.

Client—Server: A model of interaction between two programs. For example, a program operating on one network device sends a request to a program operating on another network device and waits for a response. The requesting program is referred to as the “client” while the device on which the client operates is referred to as the “client device.” The responding program is referred to as the “server,” while the device on which the server operates is referred to as the “server device.” The server is responsible for acting on the client request and returning the requested information, if any, back to the client. This requested information may be an electronic file such as a word processing document or spread sheet, a web page, or any other electronic data to be displayed or used by the client. In any given network there may be multiple clients and multiple servers. A single device may contain programming allowing it to operate both as a client device and as a server device. Moreover, a client and a server may both operate on the same device.

Web Server: A server that implements HTTP (Hypertext Transport Protocol). A web server can host a web site or a web service. A web site provides a user interface by supplying web pages to a requesting client, in this case a web browser. Web pages can be delivered in a number of formats including, but not limited to, HTML (Hyper-Text Markup Language) and XML (eXtensible Markup Language). Web pages may be generated on demand using server side scripting technologies including, but not limited to, ASP (Active Server Pages) and JSP (Java Server Pages). A web page is typically accessed through a network address. The network address can take the form of an URL (Uniform Resource Locator), IP (Internet Protocol) address, or any other unique addressing mechanism. A web service provides a programmatic interface that may be exposed using a variety of protocols layered on top of HTTP, such as SOAP (Simple Object Access Protocol).

Interface: The junction between a user and a computer program providing commands or menus through which a user communicates with the program. The term user in this context represents generally any individual or mechanism desiring to communicate with the program. For example, in the client-server model defined above, the server usually generates and delivers to a client an interface for communicating with a program operating on or controlled by the server device. Where the server is a web server, the interface is a web page. The web page, when displayed by the client device, presents a user with controls for selecting options, issuing commands, and entering text. The controls displayed can take many forms. They may include push-buttons, radio buttons, text boxes, scroll bars, or pull-down menus accessible using a keyboard and/or a pointing device such as a mouse connected to a client device. In a non-graphical environment, the controls may include command lines allowing the user to enter textual commands.

Distributed Environment: A computing environment in which various program elements needed to complete a particular task are running on different but interconnected computing devices. A distributed application is programming operating on one computing device that can be accessed and utilized by or from another computing device.

INTRODUCTION: A document is represented by a composition and a series of elements. The composition is a series of directions guiding the retrieval and placement of each element on one or more pages. To produce the document, the composition is processed. Following the composition's directions, each element is retrieved and assembled forming a coherent document. The processed composition is then delivered to a selected production service. It is expected that various embodiments of the present invention will enable one or more of the elements making up the document, as well as the document as a whole, to be manipulated as the composition is being processed. The programming responsible for processing the composition need not have any inherent knowledge of the elements or of the programming responsible for manipulating the element or elements.

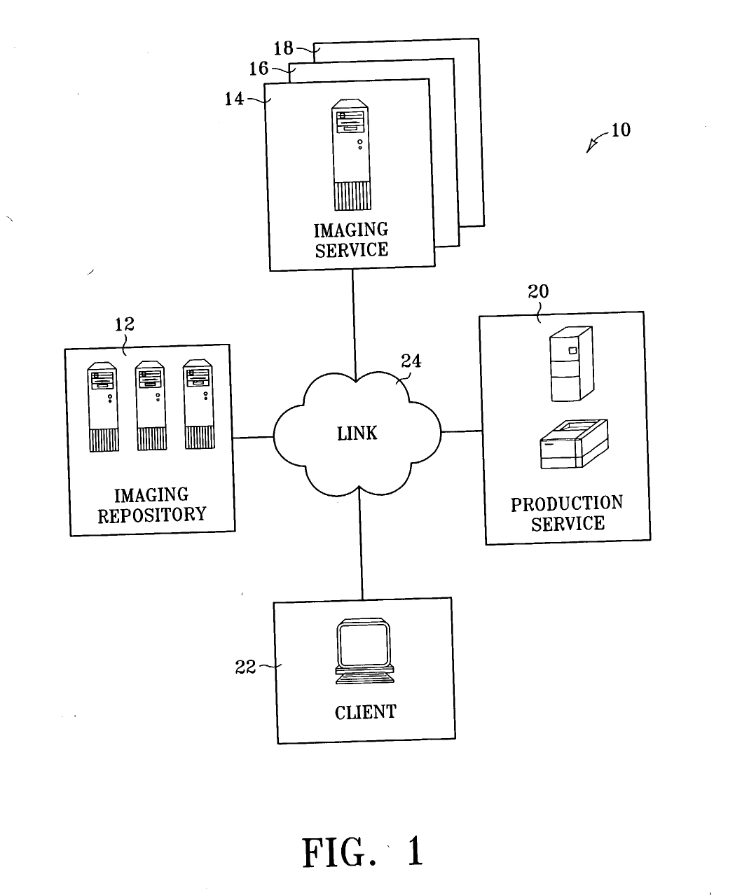

Although the various embodiments of the invention disclosed herein will be described with reference to the computer network 10 shown schematically in FIG. 1, the invention is not limited to use with network 10. The invention may be implemented in or used with any computer system in which it is necessary or desirable to produce electronic documents. The following description and the drawings illustrate only a few exemplary embodiments of the invention. Other embodiments, forms, and details may be made without departing from the spirit and scope of the invention, which is expressed in the claims that follow this description.

Referring to FIG. 1, network 10 represents generally any local or wide area network in which a variety of different component devices are linked. Network 10 includes imaging repository 12, imaging services 14, 16, and 18, production service(s) 20, and client 22. Imaging repository 12 represents generally any combination of hardware and programming capable of managing and storing electronic data. Imaging repository 12 may represent a single device, but more likely represents several devices interconnected by link 24. Imaging services 14, 16, and 18 represent generally any combination of hardware and programming capable of manipulating elements of a document, processing a composition, and/or directing a production service 20 to produce a document. Production service(s) 20 represent generally any combination of hardware and/or programming capable of producing a document. Client 22 represents generally any combination of hardware and/or programming capable of interacting with production service(s) 20 and imaging repository 12.

Link 24 interconnects imaging repository 12, imaging services 14, 16, and 18, production service(s) 20, and client 22. Link 24 represents generally a cable, wireless, or remote connection via a telecommunication link, an infrared link, a radio frequency link, or any other connector or system that provides electronic communication between components 12-22. Communication link 24 may represent an intranet, the Internet, or a combination of both. The path followed by link 24 between components 12-22 represents the logical communication path between the components, not necessarily the physical path. Components 12-22 can be connected to the network at any point and the appropriate communication path established logically between the components.

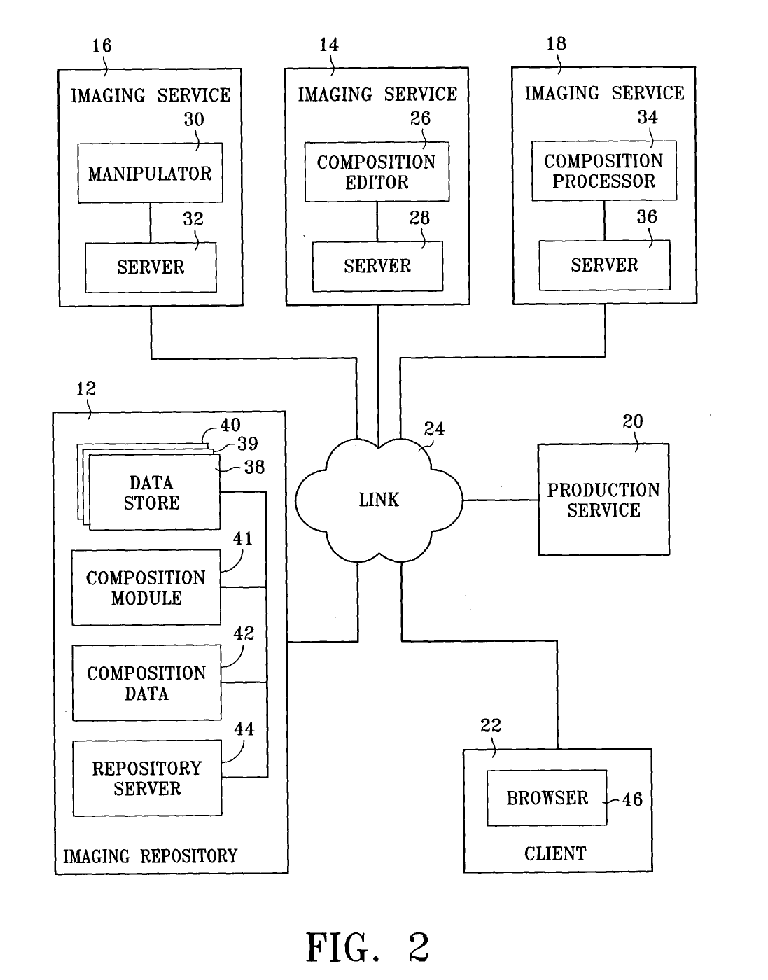

COMPONENTS: The logical components of one embodiment of the invented document production system will now be described with reference to the block diagram of FIG. 2.

In this example, imaging services 14-18 serve three functions—composition editing, element manipulating, and composition processing. Imaging service 14 includes composition editor 26 and server 28. Composition editor 26 represents any programming capable of communicating with imaging repository 12, and more specifically to provide a user interface for creating and/or editing a composition. Server 28 represents any programming capable of making composition editor 26 available over network 10.

Imaging service 16 includes manipulator 30 and server 32. Manipulator 30 represents generally any programming capable of communicating with imaging repository 12 and manipulating an element or elements of a document. Manipulation can take many forms. For example, manipulator 30 may be a graphics filter able to add a drop shadow to a selected graphic. Other common filters include buttonize, chisel, cut-out, posterize, grey scale, negative, color adjust, solarize, deformation, edge enhance, sharpen, soften, and red eye removal. Manipulator 30 may also be capable of editing assembled elements to reorganize the pages of a document. Server 32 represents any programming capable of making manipulator 30 available over network 10.

Imaging service 18 includes composition processor 34 and server 36. Composition processor 34 represents generally any programming capable of communicating with imaging repository 12, processing a selected composition, and directing a processed composition to a selected production service 20. Server 36 represents any programming capable of making composition processor 34 available over network 10.

Imaging repository 12 includes data stores 38-40, composition module 41, composition database 42, and repository server 44. Data stores 38-40 represent generally any memory for containing elements of a document. It is expected that data stores 38-40 will also include programming, web servers for example, for serving those elements and programming for limiting access to those elements. An element is accessed using an URL (Uniform Resource Locator) pointing to that element—for example—http://www.datastore.com/-element1. jpg?username-password. The portion “http://www.datastore.com” identifies the particular data store. The portion “element1.jpg” identifies the element, and the portion “?username-password” identifies credentials required by the data store to access the element. As a security measure, it is expected that data stores 38-40 will serve a specified element only upon verification of credentials. Credentials may take the form of a user name and password or any other identifying data.

Data stores 38-40 may all be located on one device or each on a separate device. These devices may be directly interconnected with one another or they may be interconnected with composition module 41 via link 24. While FIG. 2 shows three data stores 38-40, imaging repository 12 may include any number of data stores. Composition module 41 represents generally any programming capable of creating and/or editing a composition, as well as managing data in data stores 38-40. Composition database 42 represents generally any memory for containing compositions. Repository server 44 is a server responsible for making composition module 41 available over network 10.

It is expected that servers 28, 32, 36, and 44 will be web servers. Composition editor 26, manipulator 30, composition processor 34, and composition module 41, then, may be web sites, web services, or a combination of the two. Client 22 contains browser 46 capable of communicating with servers 28, 32, 36, and 44. Alternatively, in some instances, servers 28, 32, 36, and 44 may be accessed or communicated with programmatically—not using browser 46.

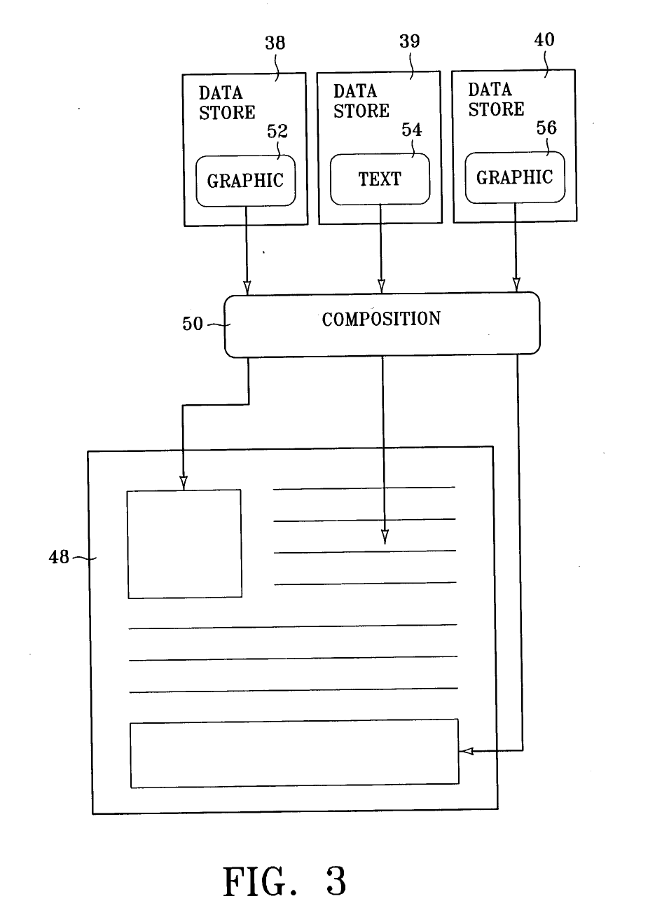

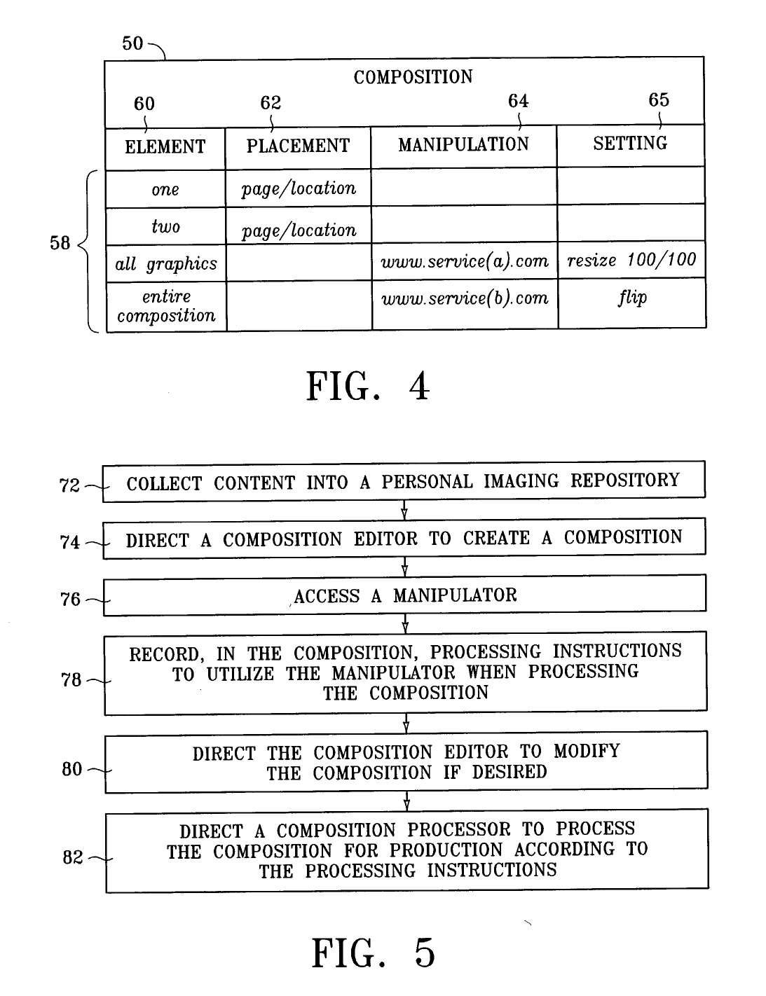

FIG. 3 is a schematic representation of a document 48 produced by processing composition 50. Document 48 is composed of three elements 52-56, each obtained from a different data store 38-40. FIG. 4 is a table illustrating a possible structure of composition 50.

In FIG. 4, composition 50 includes a number of entries 58. Each entry 58 represents a direction and includes an element field 60, a placement field 62, a manipulation field 64, and a setting field 65. Element field 60 for a given entry 58 contains data identifying an element. This, for example, may be an URL used to retrieve the element from a particular data store 38, 39, or 40. Element field 60 for an entry 58 may contain data indicating that the entry's direction applies to all elements of a particular type—all graphics for example. Element field 60 for an entry 58 may also contain data indicating that the entry's direction applies to a group of assembled elements forming document 48. Where element field 60 for an entry 58 contain data identifying an element and a data store serving that element, an URL for example, it is expected that the URL will include credentials required by the data store for accessing, retrieving, and/or modifying the particular element.

Where the element field for a given entry 58 contains data for retrieving an element, the placement field 62 for the entry 58 contains data instructing the placement of that element within document 48. Manipulation field 64 in a given entry 58 contains data identifying an imaging service responsible for manipulating the element or elements identified by data in the entry's element field 60. In this case, the manipulation field 64 for each entry 58 contains an URL used to access a particular imaging service 14, 16, or 18. Settings field 65 contains data, if needed, identifying a manipulation to be performed by an imaging service identified in manipulation field 64. In FIG. 4, for example, settings field 65 in the third entry 58 directs service(s) to resize all graphics to specified dimensions. As shown in FIG. 4, composition 50 will likely contain some entries 58 that do not reference a manipulation service. Such entries contain data for accessing and placing an element.

The block diagrams of FIG. 2, the schematic diagram of FIG. 3, and the table of FIG. 4 show the architecture, functionality, and operation of one implementation of the present invention. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that can contain, store, or maintain programming for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as a floppy diskette or hard drive, a random access memory (RAM), a read-only memory (ROM), an erasable programmable read-only memory, or a portable compact disc.

OPERATION: The operation of a document production method, according to one embodiment of the invention, will now be described with reference to the flow diagram of FIG. 5. Initially, a user collects content into imaging repository 12 (FIG. 2) (step 72). This involves saving document elements, such as text and graphics, in one or more data stores 38, 39, and/or 40. The user then directs composition editor 26 to generate a composition using the elements collected in step 72 (step 74). To do so, the user browses to a network address established for composition editor 26. Server 28 receives the communication and returns an interface enabling the user to identify each element and its placement. Selections and commands entered through the interface are returned to composition editor 26 that then directs composition module 41 to create and store a new composition 50 in composition database 42.

Next, the user accesses manipulator 30 by browsing to a network address established for manipulator 30 (step 76). Server 32 receives the communication and returns an interface enabling the user to provide directions to manipulate a selected element dr elements. Instructions entered through the interface are returned to manipulator 30. Manipulator 30 then directs composition module 41 to record, in the composition 50 created in step 74, processing directions to reflect the user's instructions entered through the interface (step 78). These instructions can include settings related to the processing to be performed. Where manipulator 30 is to sharpen an element, in this case a graphic such as a digital photograph, the instruction can include settings indicating that the image is to be sharpened, as well as the degree of sharpening. For example, a user may direct manipulator 30 to act upon a selected element.

Using the example of FIG. 4, manipulator 30 then directs composition module 41 to access an entry 58 directing placement of that element and adds an instruction indicating that manipulator 30 is to act upon the element when the composition 50 is processed. Instead, the user may direct manipulator 30 to act upon two or more elements of a particular type or on a group of assembled elements. Again, using the example of FIG. 4, manipulator 30 directs composition module 41 to add a new entry 58 that includes data in element field 60 and data in manipulator field 64 indicating that manipulator 30 is to act upon the identified elements, assembled or not, when the composition 50 is processed for production.

The user may optionally access and direct composition editor 26 to edit the composition 50 created in step 74 (step 80). The user may desire to add new elements or to change the placement of existing elements. For each new element to be added, composition editor 26 adds an entry 58 to composition 50 containing an element field 58 containing data to be used to retrieve the element and a placement field 54 containing data directing the placement of the element (although depicted in the diagram, data elements will not typically have manipulators in field 64).

The user then accesses and directs composition processor 34 to process the composition created in step 74 (step 82). To do so, the user browses to a network address established for composition processor 34. Server 36 receives the communication and returns an interface enabling the user to select a composition 50 and a production service 20. The selections made through the interface are returned. Composition processor 34 accesses imaging repository 12 and retrieves the selected composition 50, that is, the composition created in step 74. To process composition 50, composition processor 34 follows each direction making up composition 50.

Using the example of FIG. 4, composition processor 34 sequentially retrieves each entry 58 making up composition 50 and processes the data in each entry's fields 60-64. For example, composition 50 may have three entries 58 each having an entry field 60 containing data enabling the retrieval of an element. When processing an entry 58 containing an instruction to retrieve and place an element, composition processor 34 uses data in that entry's element field 60 to retrieve the particular element. As noted above, this data will likely include an URL pointing to a data store 38, 39, or 40. Before returning the element, data store 38, 39, or 40 verifies credentials contained in the URL. Once the element is retrieved, composition processor 34 uses data in the entry's placement field 62 to identify where to place the element to assemble the document. To form the document, composition processor 34 retrieves and assembles each of the elements as instructed by each of the entries in composition 50.

Where, for example, one of the entries 58 contains data in manipulator field 64 identifying a manipulator 30, composition processor 34, before forming the document, retrieves the element and instructs the identified manipulator 30 to manipulate that element. For example, where the element is a color graphic, the identified manipulator 30 may apply a grayscale filter to the graphic. The element field 60 of a given entry 58 may specify all elements of a particular type such as text or graphics. The manipulator field 64 then contains data identifying a manipulator 30 responsible for manipulating all elements of that type. Where the element field 60 contains data specifying all text, manipulator field 64 may contain data identifying a manipulator 30 capable of setting all text to a specified font type and size. Where the element field 60 contains data identifying a group of assembled elements, manipulator field 64 may contain data identifying a manipulator 30 capable of reorganizing the pages formed by those assembled elements.

Once each identified element has been retrieved, manipulated, and assembled under the directions of composition 50 created in step 74, composition processor 34 directs the processed composition 50 to the selected production service 20. Where the production service 20 is a printer, the processed composition 50 is printed. However, the selected production service 50 may well be programming capable of faxing the processed composition 50. Alternatively, the selected production service 20 may be an e-mail client capable of delivering the processed composition 50 to a particular address electronically.

Although the flow chart of FIG. 5 shows a specific order of execution, the order of execution may differ from that which is depicted. For example, the order of execution of two or more blocks may be scrambled relative to the order shown. Also, two or more blocks shown in succession in FIG. 5 may be executed concurrently or with partial concurrence. All such variations are within the scope of the present invention.

The present invention has been shown and described with reference to the foregoing exemplary embodiments. It is to be understood, however, that other forms, details, and embodiments may be made without departing from the spirit and scope of the invention, which is defined in the following claims.

What is claimed is:

1. A method for pre-production processing of an electronic document, comprising:
creating a composition comprising a series of directions for retrieving one or more elements from one or more data stores and assembling those elements into a document; and
adding a direction identifying an imaging service responsible for manipulating a particular element when the composition is processed.

2. The method of claim 1, further comprising assembling an electronic document by processing the composition according to each direction.

3. The method of claim 2, wherein creating a composition comprises creating a composition comprising a series of directions for retrieving one or more elements from one or more data stores and assembling those elements into a document, the directions for retrieving including credentials required for accessing one or more of the elements, and wherein assembling includes using the credentials to retrieve the related element or elements.

4. The method of claim 2, wherein a direction has been added identifying an imaging service responsible for manipulating a particular element, and wherein processing the composition includes directing the identified imaging service to manipulate the particular element.

5. The method of claim 2, further comprising directing the processed composition to a production service.

6. A method for pre-production processing of an electronic document, comprising:
creating a composition comprising a series of directions for retrieving one or more elements from one or more data stores and assembling those elements into a document; and
adding a direction identifying an imaging service responsible for manipulating all elements of a specified type when the composition is processed.

7. The method of claim 6, further comprising assembling an electronic document by processing the composition according to each direction.

8. The method of claim 7, wherein a given direction has been added identifying an imaging service responsible for manipulating all elements of a specified type, and wherein processing the composition includes identifying all elements of the specified type and directing the identified imaging service to manipulate those elements.

9. The method of claim 7, further comprising directing the processed composition to a production service.

10. A method for pre-production processing of an electronic document, comprising:
creating a composition comprising a series of directions for retrieving one or more elements from one or more data stores and assembling those elements into a document; and
adding to the composition a direction identifying an imaging service responsible for manipulating assembled elements when the composition is processed.

11. The method of claim 10 further comprising assembling an electronic document by processing the composition according to each direction.

12. The method of claim 11, wherein processing the composition includes assembling the elements and directing the identified imaging service to manipulate the assembled elements.

13. The method of claim 11, further comprising directing the processed composition to a production service.

14. A computer readable medium having instructions for:
creating a composition comprising a series of directions for retrieving one or more elements from one or more data stores and assembling those elements into a document; and
adding a directions identifying an imaging service responsible for manipulating a particular element when the composition is processed.

15. The medium of claim 14, having instructions for processing the composition according to each direction in order to assemble an electronic document.

16. The medium of claim 15, wherein the instructions for creating a composition comprise instructions for creating a composition comprising a series of directions for retrieving one or more elements from one or more data stores and assembling those elements into a document, the directions for retrieving including credentials required for accessing one or more of the elements, and wherein the instructions for assembling include instructions for using the credentials to retrieve the related element or elements.

17. The medium of claim 15, wherein a given direction has been added data identifying an imaging service responsible for manipulating a particular element, and wherein the instructions for processing include instructions for directing the identified imaging service to manipulate the particular element.

18. The medium of claim 15, having further instructions for directing the processed composition to a production service.

19. A computer readable medium having instructions for:
creating a composition comprising a series of directions for retrieving one or more elements from one or more data stores and assembling those elements into a document; and
adding a direction identifying an imaging service responsible for manipulating all elements of a specified type when the composition is processed.

20. The medium of claim 19, having further instructions for processing the composition according to each instruction in order to assemble an electronic document.

21. The medium of claim 20, wherein a given direction has been added identifying an imaging service responsible for manipulating all elements of a specified type, and wherein the instructions for processing the composition include instructions for identifying all elements of the specified type and directing the identified imaging service to manipulate those elements.

22. The medium of claim 20, having further instructions for directing the processed composition to a production service.

23. A computer readable medium having instructions for:
creating a composition comprising a series of directions for retrieving one or more elements from one or more data stores and assembling those elements into a document; and
adding to the composition a direction identifying an imaging service responsible for manipulating assembled elements when the composition is processed.

24. The medium of claim 23, further comprising processing the composition according to each direction in order to assemble an electronic document.

25. The medium of claim 24, wherein the instructions for processing the composition include instructions for assembling the elements and directing the identified imaging service to manipulate the assembled elements.

26. The medium of claim 24, having further instructions for directing the processed composition to a production service.

27. In a computer network, a system for pre-production processing of an electronic document, the system comprising:
an imaging repository operable to manage one or more elements and a composition comprising a series of directions for retrieving one or more of the elements and assembling those elements into a document;
a composition editor operable to communicate with the imaging repository to create and/or edit a composition;
a manipulator operable to communicate with the imaging repository to edit a composition adding directions that the manipulator is responsible for manipulating a specified element when the composition is processed.

28. The system of claim 27, further comprising a composition processor operable to communicate with the imaging repository and to assemble an electronic document by processing a composition according to each direction.

29. The system of claim 28, wherein a given direction of a composition has been added to include data identifying the manipulator as an imaging service responsible for manipulating a particular element, and wherein the composition processor, when processing the composition, is operable to direct the manipulator to manipulate the particular element.

30. The system of claim 28, wherein the composition processor is further operable to direct a processed composition to a production service.

31. In a computer network, a system for pre-production processing of an electronic document, the system comprising:
an imaging repository operable to manage one or more elements and a composition comprising a series of directions for retrieving one or more of the elements and assembling those elements into a document;
a composition editor operable to communicate with the imaging repository to create and/or edit a composition;
a manipulator operable to communicate with the imaging repository to edit a composition adding directions that the manipulator is responsible for manipulating a group of elements of a specified type when the composition is processed.

32. The system of claim 31, further comprising a composition processor operable to communicate with the imaging repository and to assemble an electronic document by processing a composition according to each direction.

33. The system of claim 32, wherein a given direction of a composition has been added and includes data identifying the manipulator as an imaging service responsible for manipulating a group of elements of a specified type, and wherein the composition processor, when processing the composition, is operable to identify the group of elements of that type and direct the manipulator to manipulate those elements.

34. The system of claim 32, wherein the composition processor is further operable to direct a processed composition to a production service.

35. In a computer network, a system for pre-production processing of an electronic document, the system comprising:
an imaging repository operable to manage one or more elements and a composition comprising a series of directions for retrieving one or more of the elements and assembling those elements into a document;
a composition editor operable to communicate with the imaging repository to create and/or edit a composition;
a manipulator operable to communicate with the imaging repository to edit a composition adding directions that the manipulator is responsible for manipulating assembled elements when the composition is processed.

36. The system of claim 35, further comprising a composition processor operable to communicate with the imaging repository and to assemble an electronic document by processing a composition according to each direction.

37. The system of claim 36, wherein a given direction of a composition has been added and includes data identifying the manipulator as an imaging service responsible for manipulating assembled elements, and wherein the composition processor, when processing the composition, is operable to assemble those elements and direct the manipulator to manipulate the assembled elements.

38. The system of claim 36, wherein the composition processor is further operable to direct a processed composition to a production service.

39. In a computer network, a system for establishing and managing a workflow for pre-production processing of an electronic document, the system comprising:
an imaging repository operable to manage one or more elements and a composition comprising a series of directions for retrieving one or more of the elements and assembling those elements into a document;
a composition editor operable to communicate with the imaging repository to create or edit a composition;
a manipulator operable to communicate with the imaging repository to edit a composition adding directions that the manipulator is responsible for manipulating a specified element when the composition is processed, to edit a composition adding directions that the manipulator is responsible for manipulating a group of elements of a specified type when the composition is processed, and to edit a composition adding directions that the manipulator is responsible for manipulating assembled elements when the composition is processed; and
a composition processor operable to communicate with the imaging repository and to assemble an electronic document by processing a composition according to each direction.

40. In a computer network, a system for pre-production processing of an electronic document, the system comprising:
a means for managing one or more elements and a composition comprising a series of directions for retrieving one or more of the elements and assembling those elements into a document;
a means for editing a composition adding directions that a specified manipulator is responsible for manipulating a specified element when the composition is processed;
a means for editing a composition adding directions that a specified manipulator is responsible for manipulating a group of elements of a specified type when the composition is processed;
a means for editing a composition adding directions that a specified manipulator is responsible for manipulating assembled elements when the composition is processed; and
a means for assembling an electronic document by processing a composition according to each direction.

41. An electronic composition for representing a document, the composition comprising:
a direction for acquiring an element of the document;
a direction for placing the element; and
a direction identifying an imaging service responsible for manipulating the element.

42. The composition of claim 41, wherein the direction for acquiring includes data locating the element and credentials needed to acquire the element.

43. The composition of claim 41, wherein the direction for identifying includes data specifying a manipulation to be performed by the identified imaging service.
